(19) United States
(12) Patent Application Publication
(10) Pub. No.: US 2020/0109740 A1
(43) Pub. Date: Apr. 9, 2020

(54) SPLINE TELESCOPIC SHAFT OF VEHICULAR PROPELLER SHAFT

(71) Applicant: TOYOTA JIDOSHA KABUSHIKI KAISHA, Toyota-shi (JP)

(72) Inventors: Satoshi JINNO, Miyoshi-shi (JP); Yuuki MIYAMOTO, Nissin-shi (JP); Ryosuke YAMAMOTO, Seto-shi (JP)

(73) Assignee: TOYOTA JIDOSHA KABUSHIKI KAISHA, Toyota-shi (JP)

(21) Appl. No.: 16/580,033

(22) Filed: Sep. 24, 2019

(30) Foreign Application Priority Data
Oct. 6, 2018 (JP) 2018-190526

(51) Int. Cl. F16C 3/03; F16D 3/06; F16D 3/84

(52) U.S. Cl. CPC F16C 3/03; F16D 2300/06; F16D 3/845; F16D 3/06

(57) ABSTRACT

A spline telescopic shaft of a vehicular propeller shaft includes a spline outer shaft and a spline inner shaft. In an outer peripheral surface of an outer spline provided on the spline inner shaft, a first portion is coated with a coating film, and a second portion is not coated with the coating film. The first portion extends from an end portion of the outer spline to a prescribed position, the end portion of the outer spline being located on a side of a distal end portion of the spline inner shaft, the prescribed position being located closer to the distal end portion of the spline inner shaft than an end surface of an inner spline is, and the end surface of the inner spline being located on a side of an opening portion of the spline outer shaft.

### INCORPORATION BY REFERENCE

The disclosure of Japanese Patent Application No. 2018-190526 filed on Oct. 6, 2018 including the specification, drawings and abstract is incorporated herein by reference in its entirety.

### BACKGROUND

### 1. Technical Field

The disclosure relates to a spline telescopic shaft of a vehicular propeller shaft that is provided with the spline telescopic shaft, and especially to retention of a lubricant for the spline telescopic shaft.

### 2. Description of Related Art

There is a vehicular propeller shaft provided with a spline telescopic shaft in which an inner shaft and an outer shaft are fitted to each other through splines. FIG. 8 is a schematic sectional view of an inner spline 264 formed on an outer shaft 260, and an outer spline 244 that is formed on an inner shaft 240 and is not coated with a resin coating film, in a conventional ordinary vehicular propeller shaft. The inner spline 264 formed on the outer shaft 260 and the outer spline 244 formed on the inner shaft 240 are able to move relative to each other as shown by an arrow due to spline fitting of the spline telescopic shaft 232. Due to this movements, a lubricant 56 present between the inner spline 264 and the outer spline 244 is raked out by a distal end surface 264a of the inner spline 264, and scatters in a direction shown by an outlined arrow, in other words, in a direction toward an outer periphery of the spline telescopic shaft 232 when the propeller shaft rotates. This may cause shortage of the lubricant 56. In order to address this, Japanese Unexamined Patent Application Publication No. 2011-174498 (JP 2011-174498 A) discloses a vehicular propeller shaft in which a groove portion is formed in a resin coating film that is formed on a surface of an outer spline such that the resin coating film is not formed in the groove portion. JP 2011-174498 A discloses a technique in which a lubricant between an outer spline of an inner shaft and an inner spline of an outer shaft for spline fitting is retained well as the lubricant is retained in the groove portion.

### SUMMARY

However, in the spline telescopic shaft described in JP 2011-174498 A, the coating film is formed along the entire length of the outer spline. Therefore, as the spline telescopic shaft extends and contracts, the lubricant is accumulated in a relatively large space formed in an area closer to an opening portion of the outer shaft than an end of the outer spline is, the relatively large space being formed between an inner peripheral surface defining the opening portion of the outer shaft, and the outer spline of the inner shaft. Then, the lubricant scatters due to centrifugal force. This may cause shortage of the lubricant.

The disclosure provides a vehicular propeller shaft in which a lubricant is retained well.

An aspect of the disclosure relates to a spline telescopic shaft of a vehicular propeller shaft. The spline telescopic shaft includes a spline outer shaft having an inner periphery provided with an inner spline; and a spline inner shaft provided with an outer spline having an outer peripheral surface that is partly coated with a coating film. A distal end portion of the spline inner shaft is fitted into an opening portion of the spline outer shaft such that the spline inner shaft and the spline outer shaft are movable relative to each other in an axis direction and are unable to rotate relative to each other. In the outer peripheral surface of the outer spline provided on the spline inner shaft, a first portion is coated with the coating film, and a second portion other than the first portion is not coated with the coating film, the first portion extending from an end portion of the outer spline to a prescribed position, the end portion of the outer spline being located on a side of the distal end portion of the spline inner shaft, the prescribed position being located closer to the distal end portion of the spline inner shaft than an end surface of the inner spline is, and the end surface of the inner spline being located on a side of the opening portion of the spline outer shaft.

In the above-described configuration, the spline outer shaft and the spline inner shaft are provided. The spline outer shaft has the inner periphery provided with the inner spline, and the spline inner shaft is provided with the outer spline having the outer peripheral surface that is partly coated with the coating film. The distal end portion of the spline inner shaft is fitted into the opening portion of the spline outer shaft such that the spline inner shaft and the spline outer shaft are movable relative to each other in the axis direction and are unable to rotate relative to each other. In the outer peripheral surface of the outer spline provided on the spline inner shaft, the first portion is coated with the coating film, the first portion extending from the end portion of the outer spline to the prescribed position, the end portion of the outer spline being located on the side of the distal end portion of the spline inner shaft, the prescribed position being located closer to the distal end portion of the spline inner shaft than the end surface of the inner spline is, and the end surface of the inner spline being located on the side of the opening portion of the spline outer shaft. In the outer peripheral surface of the outer spline provided on the spline inner shaft, the second portion other than the first portion is not coated with the coating film. Thus, a lubricant that leaks out from between the inner spline and the outer spline is appropriately retained due to its viscosity and surface tension in a relatively small space that is equivalent to a thickness of the coating film, the relatively small space being located between the outer spline and the inner spline in an area closer to the opening portion of the spline outer shaft than a step is. The step is formed due to presence and absence of the coating film. Also, since the step is located inside the inner spline of the spline outer shaft, the lubricant retained by the step is restrained from scattering in a direction toward an outer periphery of the spline telescopic shaft when the propeller shaft rotates. Since the step is always positioned inside the inner spline of the spline outer shaft, the end surface of the inner spline does not come into contact with the coating film, the end surface being located on the side of the opening portion of the spline outer shaft. Therefore, when the spline telescopic shaft extends and contracts, interference due to a difference in contraction of the coating film does not occur, and smooth sliding can be performed when the outer spline and the inner spline are fitted to each other.

In the spline telescopic shaft according to the above aspect, the first portion may be coated with the coating film in a most extended state of the spline telescopic shaft, the most extended state being permitted in advance, and the most extended state being a state in which a length of a portion of the inner spline fitted to the outer spline is shortest.

In the above-described configuration, the first portion is coated with the coating film in the most extended state of the spline telescopic shaft, the most extended state being permitted in advance, and the most extended state being the state in which the length of the portion of the inner spline fitted to the outer spline is shortest. In the outer peripheral surface of the outer spline provided on the spline inner shaft, the first portion extends from the end portion of the outer spline to the prescribed position, the end portion of the outer spline being located on the side of the distal end portion of the spline inner shaft, the prescribed position being located closer to the distal end portion of the spline inner shaft than the end surface of the inner spline is, and the end surface of the inner spline being located on the side of the opening portion of the spline outer shaft. Thus, even in the most extended state of the spline telescopic shaft, the lubricant retained by the step is further restrained from scattering in the direction toward the outer periphery of the spline telescopic shaft when the propeller shaft rotates.

In the spline telescopic shaft according to the above aspect, the coating film coating the first portion may be continuous from the end portion of the outer spline to the prescribed position, the end portion of the outer spline being located on the side of the distal end portion of the spline inner shaft.

In the above-described configuration, the coating film coating the first portion is a coating film that is continuous from the end portion of the outer spline to the prescribed position, the end portion of the outer spline being located on the side of the distal end portion of the spline inner shaft. Since the coating film on the outer peripheral surface of the outer spline is a continuous coating film, it is possible to avoid a situation where there is a difference in contraction between a force-applied portion of the coating film on the outer peripheral surface of the outer spline and a non-force-applied portion of the coating film, the force-applied portion being a portion to which force is applied from the spline outer shaft, the non-force-applied portion being located such that a discontinuous portion of the coating film is provided between the force-applied portion and the non-force-applied portion, and the non-force-applied portion being a portion to which no force is applied. Thus, when the spline telescopic shaft extends and contracts, interference due to the difference in contraction of the resin coating film does not occur, and smooth sliding can be performed when the outer spline and the inner spline are fitted to each other.

The spline telescopic shaft according to the above aspect may further include a boot that is fixed to an outer periphery defining the opening portion of the spline outer shaft and an outer periphery of a base end portion of the spline inner shaft, the boot being configured to extend and contract when the inner spline of the spline outer shaft and the outer spline of the spline inner shaft move relative to each other in the axis direction.

In the above-described configuration, the boot is further provided. The boot is fixed to the outer periphery defining the opening portion of the spline outer shaft and the outer periphery of the base end portion of the spline inner shaft, and the boot is configured to extend and contract when the inner spline of the spline outer shaft and the outer spline of the spline inner shaft move relative to each other in the axis direction. Thus, it is possible to prevent foreign matter from entering an area where the inner spline of the spline outer shaft and the outer spline of the spline inner shaft are fitted to each other, and smooth sliding is maintained when the spline telescopic shaft extends and contracts. Further, the lubricant is restrained from scattering toward the boot, and it is thus possible to restrain expansion and deformation of the boot due to adherence of the lubricant to the boot, when the propeller shaft rotates.

In the spline telescopic shaft according to the above aspect, the coating film may be a synthetic resin coating film.

In the above-described configuration, the coating film is made of a synthetic resin, preferably a wear-resistant resin such as polytetrafluoroethylene or nylon. This makes it easy to coat the outer peripheral surface of the outer spline with the coating film. Further, because elastic deformation of the coating film is large when a load is applied to the coating film, it is possible to avoid damage to the inner spline that faces the coating film.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating a schematic structure of a vehicle to which the disclosure is applied, and is also a view illustrating a schematic position of a propeller shaft in the vehicle;

FIG. 2 is a view illustrating an example of a coating film on an outer spline provided on an spline inner shaft of a spline telescopic shaft in the propeller shaft provided in the vehicle shown in FIG. 1;

FIG. 3 is a perspective view schematically showing the coating film on the outer spline shown in FIG. 2 and a lubricant present at an end portion of the coating film;

FIG. 4 is a perspective view schematically showing how a lubricant spreads in a comparative example in which an entire outer peripheral surface of an outer spline is coated with a coating film in a longitudinal direction;

FIG. 5 is a view illustrating a spline inner shaft and a spline outer shaft of the spline telescopic shaft in the propeller shaft provided in the vehicle shown in FIG. 1;

FIG. 6 is a sectional view schematically showing a movement of the lubricant when a step formed by the coating film that coats the outer spline of the spline inner shaft shown in FIG. 5 is positioned inside the spline outer shaft;

FIG. 7 is a view corresponding to FIG. 5 and schematically showing a movement of a lubricant in a comparative example in which a step formed by a coating film that covers an outer spline of a spline inner shaft is positioned outside the spline outer shaft;

FIG. 8 is a sectional view schematically showing a movement of a lubricant in related art in which a coating film that coats an outer spline of a spline inner shaft is not provided;

FIG. 9 is a view corresponding to FIG. 5 and schematically showing a movement of a lubricant in a comparative example in which a plurality of groove portions is provided in a coating film that coats an outer spline of a spline inner shaft;

FIG. 10 is a sectional view schematically showing a change in thickness of the coating film that covers the outer spline of the spline inner shaft shown in FIG. 9 when an inner spline applies a load to a part of the coating film; and

FIG. 11 is a sectional view schematically showing contact between the inner spline shown in FIG. 10 and an end surface of the coating film when the inner spline moves.

### DETAILED DESCRIPTION OF EMBODIMENTS

Hereinafter, an embodiment of the disclosure is described in detail with reference to the drawings. In the embodiment below, the drawings are simplified or deformed as appropriate, and proportions and shapes of respective parts are not necessarily depicted accurately.

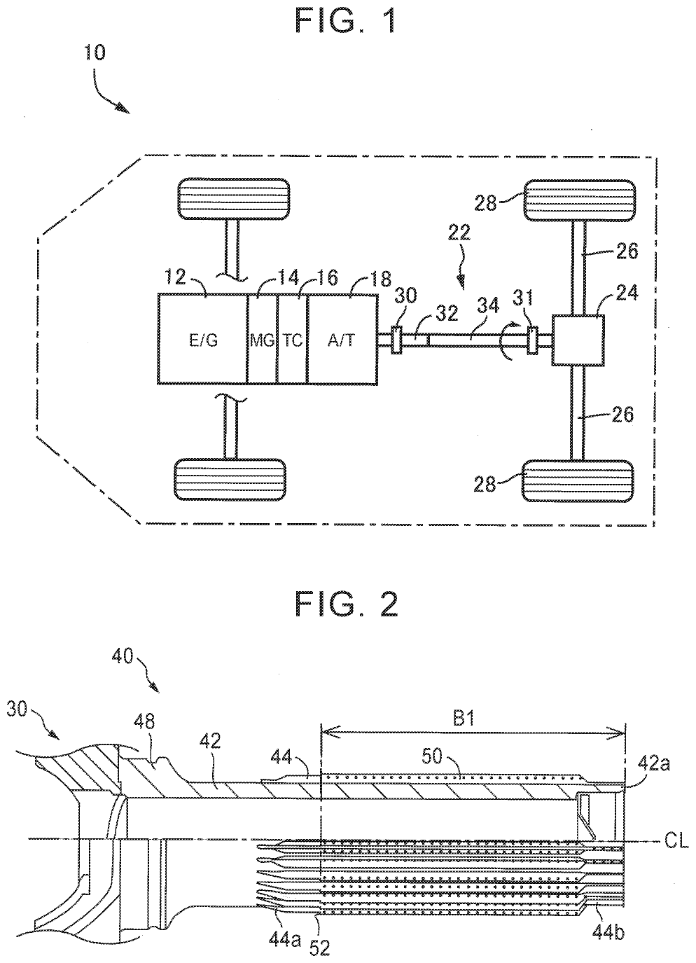

FIG. 1 is a schematic view illustrating a drive system of a vehicle 10 to which the disclosure is applied. In FIG. 1, the vehicle 10 has a front-engine rear-drive (FR) system, and is a hybrid vehicle that includes an engine 12 and a motor generator 14 as drive power sources. The engine 12 is an internal combustion engine such as a gasoline engine or a diesel engine serving as a drive power source for traveling. The motor generator 14 functions as an electric motor and a generator. Outputs of the engine 12 and the motor generator 14, in other words, rotating force is transmitted to an automatic transmission 18 from a torque converter 16 that is a fluid-type power transmission device, and further transmitted to a differential gear mechanism 24 through a propeller shaft 22. Then, axles 26 are rotated, and right and left driving wheels 28 are thus driven. The vehicle 10 is not necessarily a hybrid vehicle, and may be a vehicle in a form in which the engine 12 is connected with the automatic transmission 18 through the torque converter 16.

The propeller shaft 22 is, for example, a two-joint type propeller shaft, and includes a spline telescopic shaft 32, a tube 34 (see FIG. 1), and a universal joint 30 and a universal joint 31 that are disposed in ends of the spline telescopic shaft 32 and the tube 34 (that is, ends of the propeller shaft 22), respectively. The spline telescopic shaft 32 is extendable in a direction of an axis line CL shown in FIG. 2, and the tube 34 is made of a hollow tube. The universal joint 30 is connected with the automatic transmission 18, and the universal joint 31 is connected with the differential gear mechanism 24. The spline telescopic shaft 32 is able to extend and contract in the direction of the axis line CL of the propeller shaft 22. The universal joint 30 connected with the automatic transmission 18, and the universal joint 31 connected with the differential gear mechanism 24 are able to change an angle at which the propeller shaft 22 is connected with the automatic transmission 18 and an angle at which the propeller shaft 22 is connected with the differential gear mechanism 24, respectively. Thus, even when relative positions of the automatic transmission 18 and the differential gear mechanism 24 are changed, the propeller shaft 22 is extended or contracted, and connecting angles of the propeller shaft 22 are changed, it is possible to transmit rotation from the automatic transmission 18 to the differential gear mechanism 24.

FIG. 2 shows a part of the universal joint 30 connected with the automatic transmission 18, and a spline inner shaft 40 that is a part of the spline telescopic shaft 32. In FIG. 2, a sectional view is shown above the axis line CL of the spline inner shaft 40, and a side view is shown under the axis line CL. The spline inner shaft 40 includes a cylindrical inner shaft's shaft portion 42 that is integrally formed with a joining portion 48 and extends to a spline inner shaft distal end portion 42a, and outer splines 44 serving as outer peripheral teeth for spline fitting are formed on an outer peripheral surface of the inner shaft's shaft portion 42. The outer splines 44 are formed to extend in the direction of the axis line CL from an outer spline end portion 44a on a side of the universal joint 30 to an outer spline end portion 44b on a side of the spline inner shaft distal end portion 42a. Further, both ends of each of the outer splines 44, in other words, the outer spline end portion 44a and the outer spline end portion 44b near the spline inner shaft distal end portion 42a are lower than the remaining center portion. Further, a portion (a region) of the outer peripheral surface of each of the outer splines 44 is continuously coated with a resin coating film 50, the portion extending from the outer spline end portion 44b on the side of the spline inner shaft distal end portion 42a to a step 52 at a prescribed position. A region coated with the resin coating film 50 is shown as a first portion B1 that is a resin coating range. The joining portion 48 of the spline inner shaft 40 is fixed to the universal joint 30 by, for example, welding.

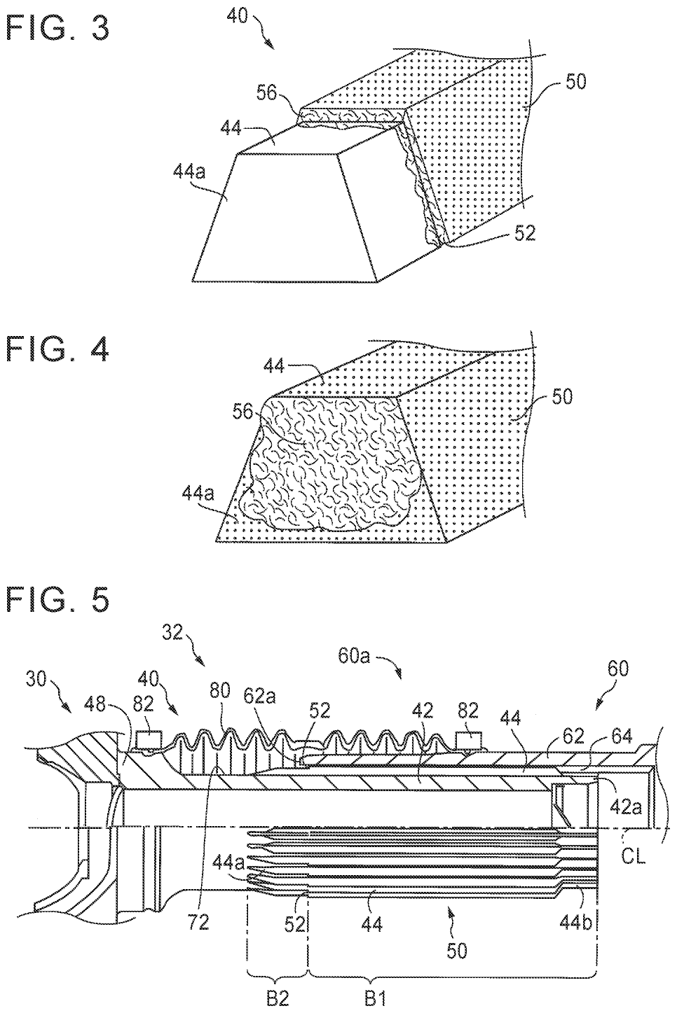

FIG. 3 schematically shows the resin coating film 50, the step 52, the outer spline end portion 44a, and the lubricant 56. The resin coating film 50 coats a portion of the outer peripheral surface of each of the outer splines 44, in other words, a portion of a surface of each of the outer peripheral teeth. The resin coating film 50 and the outer spline 44 form the step 52. Examples of the lubricant 56 include high viscosity lubricating oil and grease. As the spline telescopic shaft 32 extends or contracts, a part of the lubricant 56 retained between the outer spline 44 and the inner spline 64 (see FIG. 5) is pushed by an end surface of the inner spline 64 and moved toward the outer spline end portion 44a. The lubricant 56 moved toward the outer spline end portion 44a is retained near the step 52 formed by the outer spline 44 and the resin coating film 50. The lubricant 56 is retained inside a relatively small space that is equivalent to a thickness of the coating film 50, the space being located between the outer spline 44 and the inner spline 64 in an area closer to the outer spline end portion 44a than the step 52 is. In such a small space, due to viscosity and surface tension, the lubricant 56 is retained in an appropriate manner without flowing out by centrifugal force.

FIG. 4 schematically shows a movement of a lubricant 56 in a comparative example. In the comparative example, a resin coating film 50 is formed on the entire outer peripheral surface of each of outer splines 44, in other words, the entire surface of each of outer peripheral teeth in a longitudinal direction. As a spline telescopic shaft 32 extends and contracts, a part of the lubricant 56 retained between the outer spline 44 and an inner spline 64 is pushed by an end surface of the inner spline 64 and moved to an area closer to a universal joint 30 than the outer spline end portion 44a is. In the area closer to the universal joint 30 than the outer spline end portion 44a is, there is a relatively large space between the inner spline 64 and an inner shaft's shaft portion 42 of the spline inner shaft 40. Therefore, regardless of viscosity and surface tension of the lubricant 56, more lubricant 56 is forced to flow to the outer spline end portion 44a due to centrifugal force, as compared to the case where the resin coating film 50 coats the outer peripheral surface of the outer spline 44 and the step 52 is provided. As a result, there is a possibility that the lubricant 56 on teeth surfaces of the inner splines 64 may become insufficient.

To the contrary, with the configuration in the embodiment, as described earlier, the lubricant 56 is retained near the step 52. Therefore, the lubricant 56 is retained between teeth surfaces of the inner splines 64 and the outer splines 44.

FIG. 5 shows the spline inner shaft 40 and a spline outer shaft 60 when the spline telescopic shaft 32 in the embodiment is in a most extended state. In FIG. 5, a sectional view is shown above the axis line CL of the spline inner shaft 40 and the spline outer shaft 60, and a side view of the spline inner shaft 40 is shown under the axis line CL. The spline outer shaft 60 is fixed by welding or the like concentrically with the cylindrical tube 34 (see FIG. 1), and includes an outer shaft's shaft portion 62, and inner splines 64. The outer shaft's shaft portion 62 extends in a cylindrical shape to the side opposite to the tube 34, and has a distal end surface 62a. The inner splines 64, in other words, inner peripheral teeth, are formed on an inner peripheral surface of the outer shaft's shaft portion 62. The inner splines 64 are spline-fitted to the outer splines 44 of the inner shaft's shaft portion 42. Each of the inner splines 64 is formed on the inner peripheral surface of the outer shaft's shaft portion 62 in the direction of the axis line CL from the distal end surface 62a on the side of the universal joint 30 connected with the automatic transmission 18 to an end portion on a side of a welded part that is welded to the tube 34. The step 52 is located at a position inside the outer shaft 60, in other words, at a position closer to the spline inner shaft distal end portion 42a than the distal end surface 62a is. The distal end surface 62a is an end surface of the outer shaft's shaft portion 62, the end surface being located in an opening portion 60a of the outer shaft 60. As shown in FIG. 5, in the outer peripheral surface of each of the outer splines 44, the first portion B1 is coated with the resin coating film 50. The first portion B1 is a portion of the outer peripheral surface of each of the outer splines 44, the portion extending from the end portion 44b of the outer spline 44 to the step 52. The end portion 44b is located on the side of the spline inner shaft distal end portion 42a. In the outer peripheral surface of the outer spline 44, a second portion B2 is not coated with the resin coating film 50. The second portion B2 is the outer peripheral surface other than the first portion B1.

The spline telescopic shaft 32 further includes a boot. The boot 80 covers an outer periphery of a released portion 72 so that foreign matter are prohibited from entering the released portion 72 from an outside. The released portion 72 is a portion of the inner shaft's shaft portion 42 of the spline inner shaft 40, and the released portion is not fitted to the outer shaft's shaft portion 62. The boot 80 is made of chloroprene rubber, silicone rubber, resin, or the like and formed into a bellows shape, and the boot 80 having the bellows shape is able to extend and contract in accordance with extension and contraction of the spline telescopic shaft 32. Both ends of the boot 80 are fastened and fixed on an outer periphery of the joining portion 48 that is a base end portion of the spline inner shaft 40, and on an outer peripheral surface defining the opening portion 60a of the spline outer shaft 60 by ring-shaped fastening members 82, respectively.

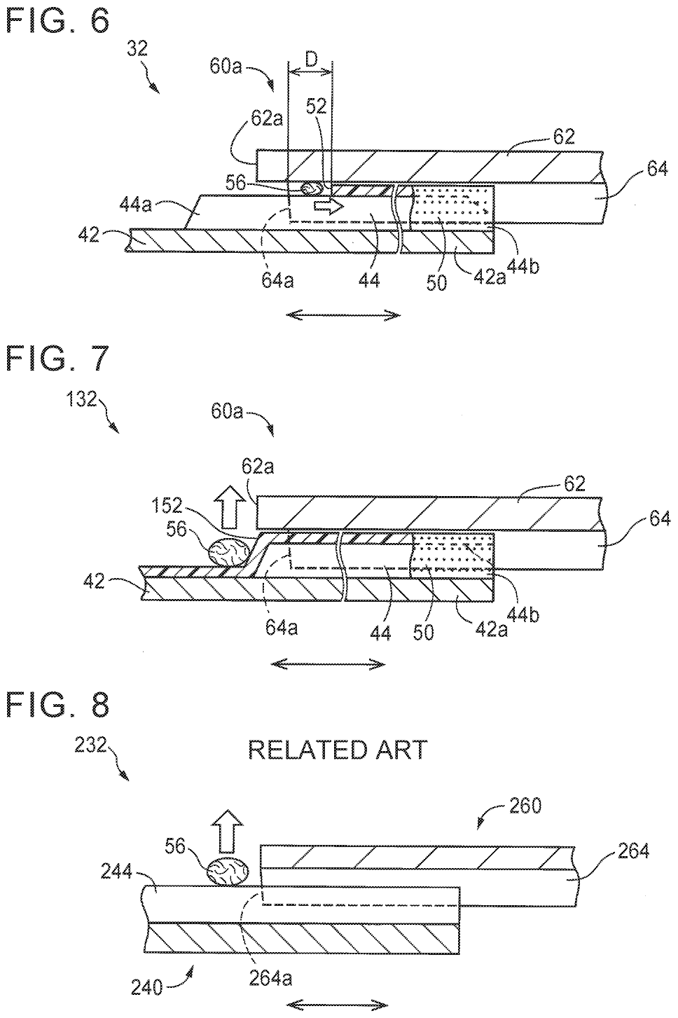

FIG. 6 is a sectional view schematically showing an example in which when the spline telescopic shaft 32 is in the most extended state, the step 52 formed by the resin coating film 50 that covers the outer peripheral surface of the outer spline 44 of the inner shaft's shaft portion 42 is stored inside an inner periphery of the inner spline 64 of the outer shaft's shaft portion 62. FIG. 6 is a side view in which a part of the resin coating film 50 is shown in a section. The resin coating film 50 coats a portion of the outer peripheral surface of the outer spline 44, the portion extending from the end portion 44b of the outer spline 44 to the step 52, the end portion 44b being located on the side of the spline inner shaft distal end portion 42a. The step 52 between the resin coating film 50 and the outer spline is set so as to be inside the spline outer shaft 60, and the step 52 is positioned closer to the spline inner shaft distal end portion 42a than the distal end surface 64a is. The distal end surface 64a is the end surface of the inner spline 64, the end surface being located on the side of the opening portion 60a of the outer shaft (i.e., the spline outer shaft) 60. In FIG. 6, a distance from the distal end surface 64a that is the end surface of the inner spline 64, which is located on the side of the opening portion 60a, to the step 52 of the resin coating film 50 is shown as a distance D between the outer shaft end portion and the coating film. The distance D between the outer shaft end portion and the coating film is set so as not to be shorter than a necessary distance Da that is determined experimentally in advance. In a state where the telescopic shaft 32 has a mean (average) extended/contracted length that is an average length during the use of the spline telescopic shaft 32, in other words, in a mean (average) extended state, a distance from the distal end surface 64a of the inner spline 64 to the step 52 may be set as the distance D between the outer shaft end portion and the coating film. Further, when the spline telescopic shaft 32 is extended to a previously-set maximum length that is permitted in design, that is, when the spline telescopic shaft 32 is in the most extended state in which the spline telescopic shaft 32 is most extended, the distance from the distal end surface 64a of the inner spline 64 to the step 52 may be set as the distance D between the outer shaft end portion and the coating film.

FIG. 7 is a sectional view schematically showing an example in which when a spline telescopic shaft 132 according to a comparative example is in a most extended state, a step 152 of a resin coating film 50 that covers an outer peripheral surface of an outer spline 44 of an inner shaft's shaft portion 42 is not stored inside an inner periphery of an inner spline 64 of an outer shaft's shaft portion 62, and the step 152 is positioned outside the inner spline 64 of the outer shaft's shaft portion 62. FIG. 7 is a side view in which a part of the resin coating film 50 is shown in a section. A solid arrow indicates relative movements of the outer spline 44 of the inner shaft's shaft portion 42 and the inner spline 64 of the outer shaft's shaft portion 62 when they are fitted to each other, in other words, extension and contraction of the spline telescopic shaft 132. Due to these movements, a lubricant 56 present between the outer spline 44 and the inner spline 64 is raked out by the step 152 of the resin coating film 50. Since the step 152 is not stored inside the inner periphery of the inner spline 64 of the outer shaft's shaft portion 62, there is a possibility that the lubricant 56 gathered near the step 152 may scatter in a direction of an outlined arrow, in other words, in a direction toward an outer periphery of the spline telescopic shaft 132 as centrifugal force is generated due to rotation of a propeller shaft 22.

In FIG. 6 according to the embodiment, a solid arrow indicates relative movements of the outer spline 44 of the inner shaft's shaft portion 42 and the inner spline 64 of the outer shaft's shaft portion 62 when they are fitted to each other, in other words, extension and contraction of the spline telescopic shaft 32. Due to these movements, the lubricant 56 between the outer spline 44 and the inner spline 64 is raked out by the step 52 of the resin coating film 50. However, in FIG. 6, the lubricant 56 raked by the step 52 of the resin coating film 50 is stored inside the relatively small space between the inner spline 64 of the outer shaft's shaft portion 62 and the outer spline 44. Even when centrifugal force is generated due to rotation of the propeller shaft 22, the viscosity and surface tension of the lubricant 56 restrain the lubricant 56 from scattering in the direction toward the outer periphery of the spline telescopic shaft 32, and as shown by an outlined arrow, the lubricant 56 returns to a space between the resin coating film 50 on the outer spline 44 and the inner spline 64. Therefore, when the spline telescopic shaft 32 extends and contracts, as the distance from the step 52 of the resin coating film 50 stored inside the inner periphery of the inner spline 64 of the outer shaft's shaft portion 62 to the distal end surface 64a of the inner spline 64 becomes longer, an amount of the lubricant 56 that scatters can be made smaller.

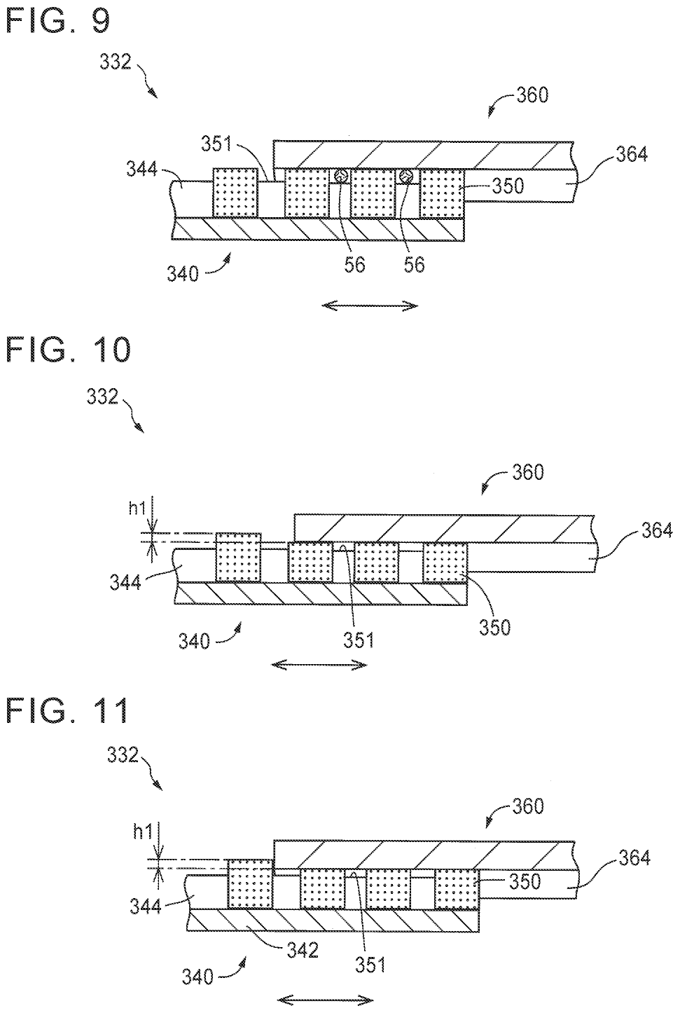

FIG. 9 is a view corresponding to FIG. 5, and is a schematic view of movement of a lubricant 56 according to a comparative example in which a plurality of groove portions 351 is provided in a resin coating film 350 that coats an outer spline 344 of a spline telescopic shaft 332. As shown in FIG. 9, a plurality of portions of the resin coating film 350 coats the outer spline 344 formed on a spline inner shaft 340 of the spline telescopic shaft 332, and the groove portions 351 that are not coated with the resin coating film 350 are provided among the portions of the resin coating film 350. Thus, the lubricant 56 is retained in the groove portions 351. Accordingly, it is possible to restrain a shortage of the lubricant 56.

However, as schematically shown in a sectional view in FIG. 10, in the case where the resin coating film 350 is partially formed, in other words, the groove portions 351 are provided in the resin coating film 350, the thickness of a material with low elasticity, that is, a material with a relatively small elastic modulus, such as resin, is greatly changed when it receives a load from the inner spline 364 formed on the spline outer shaft 360. Therefore, there is a difference between a thickness of a portion of the resin coating film 350 that receives pressure from the inner spline 364, and a thickness of a portion of the resin coating film 350 that does not receive pressure from the inner spline 364, in other words, a difference h1 in contraction is caused. Thus, as schematically shown in a sectional view in FIG. 11, an end portion of the resin coating film 350, which does not receive a load from the inner spline 364, comes into contact with the inner spline 364, and accordingly, smooth sliding cannot be performed when the outer spline 344 and the inner spline 364 are fitted to each other.

However, in the spline telescopic shaft 32 according to the embodiment shown in FIG. 6, a plurality of grooves is not formed in the resin coating film 50 on the outer peripheral surface of the outer spline 44 at least within a moving stroke of the distal end surface 64a of the inner spline 64 in an area closer to the spline inner shaft distal end portion 42a than the step 52 is. This means that the resin coating film 50 continuously coats the portion of the outer peripheral surface of the outer spline 44, the portion extending from the end portion 44b of the outer spline 44 to the step 52. The end portion 44b is located on the side of the spline inner shaft distal end portion 42a. Thus, it is possible to avoid a situation where there is a difference in contraction between a force-applied portion of the resin coating film 50 on the outer peripheral surface of the outer spline 44 and a non-force-applied portion of the resin coating film 50, the force-applied portion being a portion to which force from the spline outer shaft 60 is applied, the non-force-applied portion being located such that a groove is provided between the force-applied portion and the non-force-applied portion, and the non-force-applied portion being a portion to which no force is applied. Thus, when the spline telescopic shaft 32 extends and contracts, interference due to a difference in contraction of the resin coating film 50 does not occur, and smooth sliding can be performed when the outer spline 44 and the inner spline 64 are fitted to each other.

According to the embodiment, the spline telescopic shaft 32 of the propeller shaft 22 is provided. The spline telescopic shaft 32 includes the spline outer shaft 60 and the spline inner shaft 40. The inner splines 64 are provided on an inner periphery of the spline outer shaft 60, and the spline inner shaft 40 is provided with outer splines 44 and an outer peripheral surface of each of the outer splines 44 is partially coated with a coating film. The spline inner shaft distal end portion 42a of the spline inner shaft 40 is fitted into the opening portion 60a of the spline outer shaft 60 so that the spline inner shaft 40 and the spline outer shaft 60 are movable in the axis line CL relative to each other and are unable to rotate relative to each other. In the outer peripheral surface of each of the outer splines 44 provided on the spline inner shaft 40, the first portion B1 of the outer peripheral surface is coated with the resin coating film 50. The first portion B1 extends from the end portion 44b of the outer spline 44 to the step 52. The end portion 44b is located on the side of the spline inner shaft distal end portion 42a. The step 52 is located at the prescribed position closer to the spline inner shaft distal end portion 42a than the distal end surface 64a of the inner spline 64 is. The distal end surface 64a is located on the side of the opening portion 60a of the spline outer shaft 60. Also, in the outer peripheral surface of each of the outer splines 44 provided on the spline inner shaft 40, the second portion B2 of the outer peripheral surface other than the first portion B1 is not coated with the resin coating film 50. Thus, the lubricant 56 that leaks out from between the inner spline 64 and the outer spline 44 is appropriately retained inside a relatively small space due to viscosity and surface tension of the lubricant 56. The relatively small space is equivalent to a film thickness of the resin coating film 50, and is located between the outer spline 44 and the inner spline 64 in the area closer to the opening portion 60a of the spline outer shaft 60 than the step 52 is. The step 52 is formed due to presence and absence of the resin coating film 50. Further, since the step 52 is located inside (the inner periphery of) the inner spline 64 of the spline outer shaft 60, the lubricant 56 retained by the step 52 is restrained from scattering in the direction toward the outer periphery of the spline telescopic shaft 32 when the propeller shaft 22 rotates. Moreover, as described above, since the step 52 is always positioned inside (the inner periphery of) the inner spline 64 of the spline outer shaft 60, the distal end surface 64a on the side of the opening portion 60a of the spline outer shaft 60 does not come into contact with the resin coating film 50. Therefore, when the spline telescopic shaft 32 extends and contracts, interference due to a difference in contraction of the resin coating film 50 does not occur, and thus, smooth sliding can be performed when the outer spline 44 and the inner spline 64 are fitted to each other.

Also, according to the embodiment, in the most extended state of the spline telescopic shaft 32 where a length of a portion of the inner spline 64 fitted to the outer spline 44 is smallest, the first portion B1 of the outer peripheral surface of the outer spline 44 provided on the spline inner shaft 40 is coated with the resin coating film 50. The most extended state is permitted in advance. The first portion B1 extends from the end portion 44b of the outer spline 44 to the step 52. The end portion 44b is located on the side of the spline inner shaft distal end portion 42a. The step 52 is located closer to the distal end portion of the spline inner shaft 40 than the distal end surface 64a is. The distal end surface 64a is on the side of the opening portion 60a of the spline outer shaft 60. Thus, even in the most extended state of the spline telescopic shaft 32, the lubricant 56 retained by the step 52 is restrained further from scattering in the direction toward the outer periphery of the spline telescopic shaft 32 when the propeller shaft 22 rotates.

Moreover, according to the embodiment, the resin coating film 50 coating the first portion B1 is a coating film that is continuous from the end portion 44b of the outer spline 44, which is located on the side of the spline inner shaft distal end portion 42a, to the step 52. Since the resin coating film 50 on the outer peripheral surface of the outer spline 44 is a continuous coating film, it is possible to avoid a situation where there is a difference in contraction between a force-applied portion of the resin coating film 50 and a non-force-applied portion of the resin coating film 50, the force-applied portion being a portion to which force is applied from the spline outer shaft 60, the non-force-applied portion being located such that a discontinuous portion of the resin coating film 50 is provided between the force-applied portion and the non-force-applied portion, and the non-force-applied portion being a portion to which no force is applied. Thus, when the spline telescopic shaft 32 extends and contracts, interference due to the difference in contraction of the resin coating film 50 does not occur, and smooth sliding can be performed when the outer spline 44 and the inner spline 64 are fitted to each other.

Furthermore, according to the embodiment, the boot 80 is further provided. The boot 80 is fixed to the outer periphery defining the opening portion 60a of the spline outer shaft 60 and to the outer periphery of the joining portion 48 that is a base end portion of the spline inner shaft 40. The boot 80 is configured to extend and contract when the inner spline 64 of the spline outer shaft 60 and the outer spline 44 of the spline inner shaft 40 move relative to each other in the direction of the axis line CL. Thus, it is possible to prevent foreign matter from entering an area where the inner spline 64 of the spline outer shaft 60 and the outer spline 44 of the spline inner shaft 40 are fitted to each other, and smooth sliding is maintained while the spline telescopic shaft 32 is extending and contracting. Also, with the configuration according to the embodiment, the lubricant 56 is restrained from scattering to the boot 80, and it is possible to restrain expansion and deformation of the boot 80 due to adhesion of the lubricant 56 to the boot 80, when the propeller shaft 22 is rotating.

Moreover, according to the embodiment, a synthetic resin, preferably a wear-resistant resin, such as polytetrafluoroethylene or nylon, is used as the coating film. Thus, it becomes easy to coat the outer peripheral surface of the outer spline 44 with the coating film. Also, because elastic deformation of the coating film is large when a load is applied to the coating film, it is possible to avoid damage to the inner spline 64 that faces the coating film.

The disclosure has been described based on the embodiment of the disclosure. However, the disclosure is applied in other forms.

For example, in the foregoing embodiment, the resin coating film 50 continuously coats a portion of the outer peripheral surface of the outer spline 44, the portion extending from the spline inner shaft distal end portion 42a to the step 52. However, the resin coating film 50 may intermittently coat a portion of the outer peripheral surface of the outer spline 44, the portion extending from the spline inner shaft distal end portion 42a to the step 52. For example, a groove portion that is not coated with the resin coating film 50, in other words, a lubricant retention groove may be provided to extend in a circumferential direction or an axial direction such that the lubricant 56 is retained in the lubricant retention groove. In the foregoing embodiment, a resin coating film is used as the coating film. However, the coating film made of a material other than resin may be used.

The foregoing embodiment is merely one example, and the disclosure may be carried out in a form where various changes and improvements are added based on knowledge of a person skilled in the art.

What is claimed is:

1. A spline telescopic shaft of a vehicular propeller shaft, the spline telescopic shaft comprising:
a spline outer shaft having an inner periphery provided with an inner spline; and
a spline inner shaft provided with an outer spline having an outer peripheral surface that is partly coated with a coating film, wherein:
a distal end portion of the spline inner shaft is fitted into an opening portion of the spline outer shaft such that the spline inner shaft and the spline outer shaft are movable relative to each other in an axis direction and are unable to rotate relative to each other; and
in the outer peripheral surface of the outer spline provided on the spline inner shaft, a first portion is coated with the coating film, and a second portion other than the first portion is not coated with the coating film, the first portion extending from an end portion of the outer spline to a prescribed position, the end portion of the outer spline being located on a side of the distal end portion of the spline inner shaft, the prescribed position being located closer to the distal end portion of the spline inner shaft than an end surface of the inner spline is, and the end surface of the inner spline being located on a side of the opening portion of the spline outer shaft.

2. The spline telescopic shaft according to claim 1, wherein the first portion is coated with the coating film in a most extended state of the spline telescopic shaft, the most extended state being permitted in advance, and the most extended state being a state in which a length of a portion of the inner spline fitted to the outer spline is shortest.

3. The spline telescopic shaft according to claim 1, wherein the coating film coating the first portion is continuous from the end portion of the outer spline to the prescribed position, the end portion of the outer spline being located on the side of the distal end portion of the spline inner shaft.

4. The spline telescopic shaft according to claim 1, further comprising a boot that is fixed to an outer periphery defining the opening portion of the spline outer shaft and an outer periphery of a base end portion of the spline inner shaft, the boot being configured to extend and contract when the inner spline of the spline outer shaft and the outer spline of the spline inner shaft move relative to each other in the axis direction.

5. The spline telescopic shaft according to claim 1, wherein the coating film is a synthetic resin coating film.
